(19) United States
(12) Patent Application Publication
(10) Pub. No.: US 2026/0022938 A1
(43) Pub. Date: Jan. 22, 2026

(54) INERTIAL MEASUREMENT APPARATUS FOR THREE-AXIS MECHANICAL GIMBAL

(71) Applicant: EHANG INTELLIGENT EQUIPMENT (GUANGZHOU) CO., LTD., Guangzhou (CN)

(72) Inventors: Huazhi HU, Guangzhou (CN); Yong LIU, Guangzhou (CN); Haisheng HU, Guangzhou (CN)

(73) Assignee: EHANG INTELLIGENT EQUIPMENT (GUANGZHOU) CO., LTD., Guangzhou (CN)

(21) Appl. No.: 18/993,015

(22) PCT Filed: Jun. 30, 2023
(86) PCT No.: PCT/CN2023/104664

§ 371 Date: Jan. 10, 2025

(30) Foreign Application Priority Data
Jul. 28, 2022 (CN) 202221978476.9

(51) Int. Cl. G01C 21/16; F16M 11/12; G03B 15/00; G03B 17/56

(52) U.S. Cl. CPC G01C 21/16; F16M 11/123; G03B 17/561; G03B 15/006

(57) ABSTRACT

The provided is an inertial measurement apparatus for a three-axis mechanical gimbal, including a mounting plate, an inertial measurement module, a control module and a heating module. The inertial measurement module, the control module and the heating module are all arranged on the mounting plate. The control module is connected to the heating module. The control module is configured to control the heating module to work. The inertial measurement module is provided with a temperature measurement unit which is communicatively connected to the control module. When the temperature of the inertial measurement module is lower than a target temperature value, the control module controls the heating module to be turned on, so that the inertial measurement module is heated. When the temperature of the inertial measurement module is higher than the target temperature value, the control module controls the heating module to be turned off.

### CROSS-REFERENCE TO THE RELATED APPLICATIONS

This application is the national phase entry of International Application No. PCT/CN2023/104664, filed on Jun. 30, 2023, which is based upon and claims priority to Chinese Patent Application No. 202221978476.9, filed on Jul. 28, 2022, the entire contents of which are incorporated herein by reference.

### TECHNICAL FIELD

The present invention pertains to the field of unmanned aerial vehicle technology, particularly to an inertial measurement apparatus for a three-axis mechanical gimbal.

### BACKGROUND

Aerial vehicles are often equipped with cameras, and a gimbal is the platform on the aerial vehicles that supports the cameras, enabling the later conduct aerial photography of the ground from the air. The gimbal can realize the fixation of the camera, adjust the attitude of the camera (e.g., change the height and direction of the camera), and stabilize the camera in a determined attitude, thereby achieving stable, smooth, and multi-angle shooting. A three-axis mechanical gimbal, compared to two-axis and single-axis gimbals, has better stabilization effects and diversity of attitude adjustments. To monitor and adjust the attitude, an IMU is installed on the gimbal. IMU, i.e., Inertial Measurement Unit, is a device that measures the three-axis attitude angles (or angular rates) and acceleration of an object. Existing gimbals are susceptible to the influence of external environmental temperatures during operation, which can cause the zero bias of the IMU inertial navigation devices inside the gimbal to change easily. This may lead to errors of attitude detection, resulting in tilted images from the camera mounted on the gimbal and affecting the photography and video experience.

Existing technology discloses an installation structure for an inertial measurement unit, including an inertial measurement unit; an installation carrier on which the inertial measurement unit is installed; a support member that provides support for the installation carrier and the inertial measurement unit; and a buffering structure through which the installation carrier is installed on the support member. The buffering structure has flexible and/or elastic materials capable of absorbing the distortion of the support member.

### SUMMARY

The purpose of the present invention is to provide an inertial measurement apparatus for a three-axis mechanical gimbal that enables an inertial measurement module to operate at a constant temperature, thereby ensuring the photography effect of a gimbal camera.

To achieve the aforementioned purpose, the present invention provides an inertial measurement apparatus for a three-axis mechanical gimbal, including a mounting plate, an inertial measurement module, a control module and a heating module. The inertial measurement module, the control module and the heating module are all arranged on the mounting plate. The control module is connected to the heating module. The control module is configured to control the heating module to work. The inertial measurement module is provided with a temperature measurement unit which is communicatively connected to the control module.

As a preferred embodiment, the inertial measurement module and the heating module are respectively arranged on the opposite sides of the mounting plate.

As a preferred embodiment, the inertial measurement apparatus for a three-axis mechanical gimbal further includes a switch module. The control module, the switch module and the heating module are electrically connected in sequence, and the control module controls the operation of the heating module by controlling the on-off state of the switch module.

As a preferred embodiment, the control module is an MCU microcontroller module, and the switch module is a MOSFET (Metal-Oxide-Semiconductor Field-Effect Transistor) switch. An IO port of the MCU microcontroller module is connected to the MOSFET switch, enabling the MCU microcontroller module to control the power supply and power off of the heating module by controlling the MOSFET switch through the IO port.

As a preferred embodiment, the MCU microcontroller module and the inertial measurement module are arranged on the same side of the mounting plate, while the MOSFET switch and the heating module are arranged on the opposite side of the mounting plate.

As a preferred embodiment, the control module includes a communication unit and a proportion integration differentiation (PID) controller. The communication unit, the PID controller and the MOSFET switch are connected in sequence, and the communication unit is connected to the temperature measurement unit.

As a preferred embodiment, the control module also includes a PWM output circuit. The PID controller is connected to the MOSFET switch through the PWM output circuit. As a preferred embodiment, the heating module is a power resistor.

As a preferred embodiment, the mounting plate is a PCB board.

As a preferred embodiment, the control module is connected to the inertial measurement module via a serial peripheral interface (SPI) bus or an I2C bus to obtain temperature information from the temperature measurement unit.

Compared with the prior art, the beneficial effect of this invention is as follows:
The present invention monitors the temperature of the inertial measurement module through the temperature measurement unit of the same. The control module obtains the temperature of the inertial measurement module. When the temperature of the inertial measurement module is lower than a target temperature value, the control module controls the heating module to be turned on, thereby increasing the environmental temperature where the inertial measurement module located and heating the inertial measurement module. When the temperature of the inertial measurement module is higher than the target temperature value, the control module controls the heating module to be turned off, thereby decreasing the environmental temperature where the inertial measurement module located and cooling the inertial measurement module. Therefore, the inertial measurement module works in a relatively stable temperature state, thereby implementing the constant temperature control function of the inertial measurement module, preventing a zero-offset change of the inertial measurement module due to the influence of the temperature, and ensuring the photographing effect of the gimbal camera.

### BRIEF DESCRIPTION OF THE DRAWINGS

FIG. 1 is a schematic structural diagram of the inertial measurement apparatus for a three-axis mechanical gimbal provided by an embodiment of the present invention;

FIG. 2 is a block diagram of the principle of the inertial measurement apparatus for a three-axis mechanical gimbal provided by an embodiment of the present invention; and

FIG. 3 is a schematic diagram of the working state of the inertial measurement apparatus for a three-axis mechanical gimbal provided by an embodiment of the present invention.

In the figures, 100—mounting plate, 200—inertial measurement module, 210—temperature measurement unit, 300—control module, 310—communication unit, 320—PID controller, 330—PWM output circuit, 400—heating module, and 500—switch module.

### DETAILED DESCRIPTION OF THE EMBODIMENTS

Combined with the accompanying drawings and embodiments, a further detailed description of the specific implementation of this invention is provided below. The following embodiments are used to illustrate the invention, but are not intended to limit the scope of the invention.

In the description of the invention, it should be noted that terms such as “center”, “longitudinal”, “lateral”, “up”, “down”, “front”, “back”, “left”, “right”, “vertical”, “horizontal”, “top”, “bottom”, “inner”, “outer”, etc., which indicate directions or positional relationships, are based on the directions or positional relationships shown in the drawings. They are used only for the convenience of describing the invention and simplifying the description, and do not indicate or imply that the devices or components referred to must have specific orientations or be constructed and operated in specific orientations. Therefore, they should not be understood as limitations of the present invention.

In the description of this invention, it should be noted that unless otherwise specifically defined and limited, terms such as “mounting”, “connected” and “connecting” should be understood broadly. For example, they may indicate fixed connections, detachable connections or integral connections; they may also indicate mechanical connections or electrical connections; they may also indicate direct connections or indirect connections through intermediate media, or internal connections between two components. For a person of ordinary skill in the field, the specific meanings of above terms in the context of this invention can be understood according to the specific cases.

### Embodiment 1

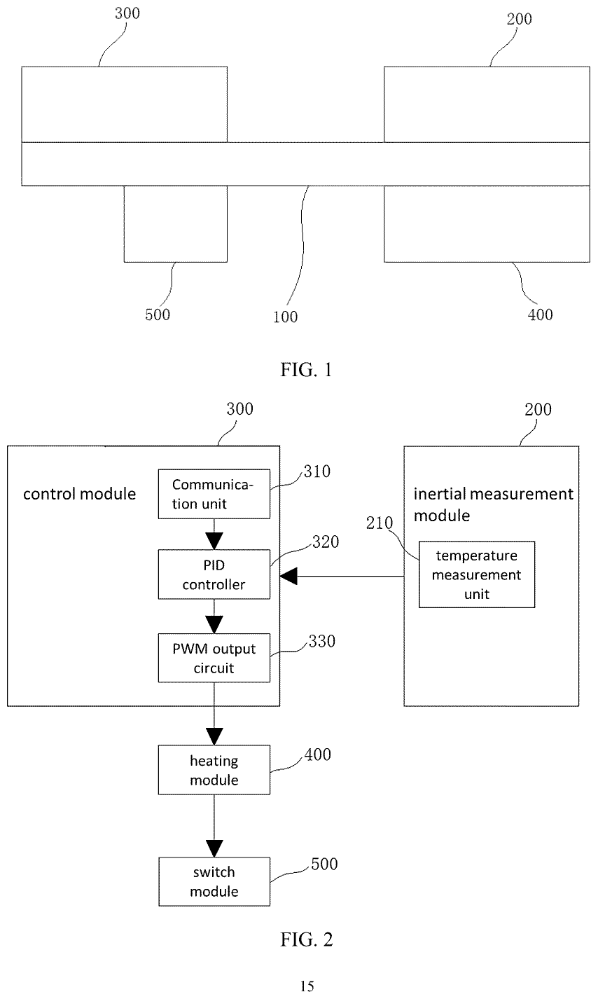

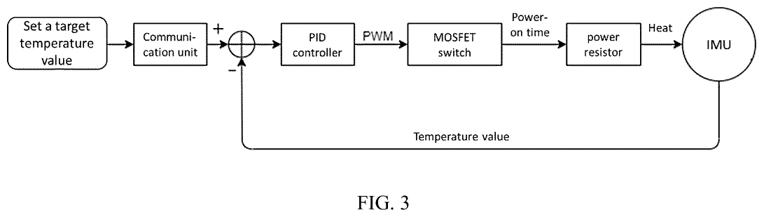

As shown in FIGS. 1, 2 and 3, a preferred embodiment of an inertial measurement apparatus for a three-axis mechanical gimbal, based on the present invention, includes a mounting plate 100, an inertial measurement module 200, a control module 300 and a heating module 400. The inertial measurement module 200, control module 300 and heating module 400 are all arranged on the mounting plate 100. The control module 300 is connected to the heating module 400. The control module 300 is configured to control the operation of the heating module 400. The inertial measurement module 200 includes a temperature measurement unit 210 that is communicatively connected to the control module 300. This embodiment monitors the temperature of the inertial measurement module 200 by the temperature measurement unit 210 of the inertial measurement module 200. The control module 300 obtains the temperature of the inertial measurement module 200. When the temperature of the inertial measurement module 200 is lower than a target temperature value, the control module 300 controls the heating module 400 to be turned on, thereby increasing the environmental temperature around the inertial measurement module 200 and heating the inertial measurement module 200. When the temperature of the inertial measurement module 200 is higher than the target temperature value, the control module 300 controls the heating module 400 to be turned off, thereby decreasing the environmental temperature around the inertial measurement module 200 and cooling the inertial measurement module 200. Therefore, the inertial measurement module 200 works in a relatively stable temperature state, achieving constant temperature control function of the inertial measurement module 200, preventing a zero-offset change of the inertial measurement module 200, and thus ensuring the photographing effect of the gimbal camera.

Additionally, in this embodiment, the inertial measurement module 200, control module 300 and heating module 400 are all connected to the mounting plate 100, which enhances the integrity of the device. The heat generated by the heating module 400 can be conducted to the inertial measurement module 200 through the mounting plate 100, improving heating efficiency.

Furthermore, in this embodiment, the inertial measurement module 200 and heating module 400 are respectively arranged on opposite sides of the mounting plate 100, which helps the heat generated by the heating module 400 to be effectively and quickly conducted to the inertial measurement module 200. Moreover, the centers of the inertial measurement module 200 and heating module 400 of the present embodiment are aligned on the same straight line, positioning the inertial measurement module 200 right against the heating module 400 and allowing the heating module 400 to accurately provide heat to the inertial measurement module 200.

Specifically, this embodiment of the inertial measurement apparatus for a three-axis mechanical gimbal also includes a switch module 500. The control module 300, switch module 500 and heating module 400 are electrically connected in sequence. The control module 300 controls the operation of the heating module 400 by controlling the on-off state of the switch module 500. When the temperature of the inertial measurement module 200 is below a target temperature value, the control module 300 controls the switch module 500 to turn on, connecting the heating module 400 and activating the same to heat the inertial measurement module 200. When the temperature of the inertial measurement module 200 is higher than a target temperature value, the control module 300 controls the switch module 500 to turn off, disconnecting from the heating module 400 to shut it down and allow the inertial measurement module 200 to cool down gradually.

In addition, in another specific embodiment, a heat dissipation module is also connected to the mounting plate 100. The heat dissipation module and the inertial measurement module 200 are located on the same side of the mounting plate 100. The control module 300 is connected to the heat dissipation module and the control module 300 is used to control the operation of the heat dissipation module. Specifically, the heat dissipation module may be a fan which can rapidly dissipate heat from the inertial measurement module 200, achieving cooling of the same. Similarly, a switch module 500 is also provided between the control module 300 and the heat dissipation module. The control module 300 controls the operation of the heat dissipation module by controlling the on-off state of the switch module 500.

### Embodiment 2

This embodiment differs from Embodiment 1 in that, on the basis of the Embodiment 1, this embodiment provides a further description of the control module 300, switch module 500 and heating module 400.

In this embodiment, the control module 300 is an MCU microcontroller module, and the switch module 500 is a MOSFET switch. An IO port of the MCU microcontroller module is connected to the MOSFET switch, allowing the MCU microcontroller module to control the power supply and power off of the heating module 400 by controlling the MOSFET switch through the IO port. The MCU microcontroller module can adjust the heating time of the heating module 400 by controlling the switching time of the MOSFET switch.

The control module 300 utilizes the MCU microcontroller module. MCU (Microcontroller Unit), also known as a single-chip microcomputer or a monolithic microcomputer, is small in size, allowing a device to be small and easy to install on a gimbal. The MCU is capable to read data from sensors, such as temperature sensors, and read the measurements from the temperature measurement unit 210 of the inertial measurement module 200, making it very suitable for the device in this embodiment.

The switch module 500 utilizes the MOSFET switch. MOSFET switches have high input impedance and low driving power, resulting in less energy consumption for the device and saving energy. Moreover, the switching speed is fast, allowing for quick response to the control module 300, enabling rapid activation and deactivation of the heating module 400, and improving the timeliness of temperature control for the inertial measurement module 200. Additionally, MOSFET switches do not experience secondary breakdown, significantly reducing the damage rate and enhancing the durability of the device. Furthermore, after conducting electricity, the conductive characteristics of a MOSFET switch are purely resistive, which has an automatic current balancing effect, ensuring the stable operation of the heating module 400.

Specifically, in this embodiment, the MCU microcontroller module and the inertial measurement module 200 are arranged on the same side of the mounting plate 100, while the MOSFET switch and the heating module 400 are arranged on the opposite side of the mounting plate 100. Reasonably allocating the positions of the MCU microcontroller module, inertial measurement module 200, MOSFET switch and heating module 400 on the mounting plate 100 results in a smaller area for the mounting plate 100, thereby reducing the size of the device, improving its integrity and facilitating easier installation on the gimbal. Furthermore, the MCU microcontroller module and the MOSFET switch are aligned on the same straight line, and the inertial measurement module 200 and the heating module 400 are aligned on the same straight line, positioning the MCU microcontroller module and the heating module 400 at opposite ends of the mounting plate 100. This keeps the MCU microcontroller module and the heating module 400 at a greater distance from each other, reduces the influence of the heating module 400 on the MCU microcontroller module and avoids high temperatures that could affect the operation of the MCU microcontroller module.

Other parts of this embodiment are the same as in Embodiment 1 and will not be repeated herein.

### Embodiment 3

This embodiment differs from Embodiment 2 in that, on the basis of the Embodiment 2, this embodiment provides a further description of the control module 300, heating module 400 and mounting plate 100, and the connection between the control module 300 and the inertial measurement module 200.

In this embodiment, the control module 300 includes a communication unit 310 and a PID controller 320. The communication unit 310, the PID controller 320 and the MOSFET switch are connected in sequence. The communication unit 310 is connected to the temperature measurement unit 210. The communication unit 310 is configured to communicate and receive an overall control of an aerial vehicle, specifically receiving a target temperature value set by the aerial vehicle for the inertial measurement module 200 to operate. The received target temperature value is compared with the temperature measurement unit 210 through the PID controller 320 to obtain a difference. This difference is used to calculate a new input value making the data of the system reach or maintain a reference value. The PID controller 320 may adjust the input value according to historical date and the occurrence rate of the differences, making the system more accurate and stable. The communication unit 310 based on this embodiment, after obtaining a target temperature value, runs a PID control algorithm through the PID controller 320 and outputs a switch time for controlling the on-off state of the MOSFET switch.

Furthermore, the control module 300 based on this embodiment also includes a PWM output circuit 330. The PID controller 320 is connected to the MOSFET switch by the PWM output circuit 330. The PWM output circuit 330 is configured to make signals from the control module 300 to the MOSFET switch are in digital form, no need for analog-to-digital conversion. Keeping the signals in digital form minimizes noise interference, offering strong noise resistance, and is economical and space-saving. The communication unit 310, the PID controller 320 and the PWM output circuit 330 are integrated on the MCU microcontroller module.

Additionally, the heating module 400 based on this embodiment is a power resistor. The heating module 400 generates heat when powered. Moreover, the mounting plate 100 is a PCB board on which various circuits of the apparatus can be printed, making the apparatus more simple and convenient to use.

In this embodiment, the control module 300 is connected to the inertial measurement module 200 by a SPI bus or an I2C bus to obtain temperature information of the temperature measurement unit 210.

Thus, after the communication unit 310 obtains the target temperature value set by users, the control module 300 acquires a temperature value measured by the temperature measurement unit 210 of the inertial measurement module 200 through the SPI bus or the I2C bus, then runs the PID control algorithm through the PID controller 320 and outputs a pulse width modulation (PWM) signal through the PWM output circuit 330 to control the switch time of the MOSFET switch. The heating module 400 generates heat when powered, and the heat is conducted to the inertial measurement module 200 through the mounting plate 100, ultimately achieving the constant temperature control function of the inertial measurement module 200.

Other parts of this embodiment are the same as in Embodiment 2 and will not be repeated herein.

In summary, embodiments of the present invention provide an inertial measurement apparatus for a three-axis mechanical gimbal, which monitors the temperature of the inertial measurement module 200 through the temperature measurement unit 210 of the inertial measurement module 200. The control module 300 obtains the temperature of the inertial measurement module 200. When the temperature of the inertial measurement module 200 is below a target temperature value, the control module 300 controls the heating module 400 to activate, increasing the environmental temperature around the inertial measurement module 200 and warming the inertial measurement module 200 up. When the temperature of the inertial measurement module 200 is higher than a target temperature value, the control module 300 controls the heating module 400 to turn off, decreasing the environmental temperature around the inertial measurement module 200 to cool it down. It makes the inertial measurement module 200 work in a relatively stable temperature state, achieving constant temperature control function of the inertial measurement module 200, preventing a zero-offset change of the inertial measurement module 200 affected by temperature changes, and thus ensuring the photographing effect of the gimbal camera.

The above descriptions are preferred embodiments of the present invention. It should be noted that for a person of ordinary skill in the art, several improvements and substitutions can be made without deviating from the technical principles of the present invention, which shall be all included within the scope of protection of the present invention.

What is claimed is:

1. An inertial measurement apparatus for a three-axis mechanical gimbal, comprising a mounting plate, an inertial measurement module, a control module and a heating module; wherein the inertial measurement module, the control module and the heating module are all arranged on the mounting plate; wherein the control module is connected to the heating module; wherein the control module is configured to control the heating module to work; and wherein the inertial measurement module is provided with a temperature measurement unit and the temperature measurement unit is communicatively connected to the control module.

2. The inertial measurement apparatus for the three-axis mechanical gimbal according to claim 1, wherein the inertial measurement module and the heating module are respectively arranged on the opposite sides of the mounting plate.

3. The inertial measurement apparatus for the three-axis mechanical gimbal according to claim 1, further comprising a switch module, wherein the control module, the switch module and the heating module are electrically connected in sequence, and the control module-controls an operation of the heating module by controlling an on-off state of the switch module.

4. The inertial measurement apparatus for the three-axis mechanical gimbal according to claim 3, wherein the control module is an MCU microcontroller module, and the switch module is a metal-oxide-semiconductor field-effect transistor (MOSFET) switch; wherein an IO port of the MCU microcontroller module is connected to the MOSFET switch, enabling the MCU microcontroller module to control power supply and power off of the heating module by controlling the MOSFET switch through the IO port.

5. The inertial measurement apparatus for the three-axis mechanical gimbal according to claim 4, wherein the MCU microcontroller module and the inertial measurement module are arranged on an identical side of the mounting plate, while the MOSFET switch and the heating module are arranged on an opposite side of the mounting plate.

6. The inertial measurement apparatus for the three-axis mechanical gimbal according to claim 4, wherein the control module comprises a communication unit and a proportion integration differentiation (PID) controller, wherein the communication unit, the PID controller and the MOSFET switch are connected in sequence, and the communication unit is connected to the temperature measurement unit.

7. The inertial measurement apparatus for the three-axis mechanical gimbal according to claim 6, wherein the control module further comprises a pulse width modulation (PWM) output circuit, and the PID controller is connected to the MOSFET switch through the PWM output circuit.

8. The inertial measurement apparatus for the three-axis mechanical gimbal according to claim 1, wherein the heating module is a power resistor.

9. The inertial measurement apparatus for the three-axis mechanical gimbal according to claim 1, wherein the mounting plate is a PCB board.

10. The inertial measurement apparatus for the three-axis mechanical gimbal according to claim 1, wherein the control module is connected to the inertial measurement module via a serial peripheral interface (SPI) bus or an I2C bus to obtain temperature information from the temperature measurement unit.

11. The inertial measurement apparatus for the three-axis mechanical gimbal according to claim 2, wherein the heating module is a power resistor.

12. The inertial measurement apparatus for the three-axis mechanical gimbal according to claim 3, wherein the heating module is a power resistor.

13. The inertial measurement apparatus for the three-axis mechanical gimbal according to claim 4, wherein the heating module is a power resistor.

14. The inertial measurement apparatus for the three-axis mechanical gimbal according to claim 5, wherein the heating module is a power resistor.

15. The inertial measurement apparatus for the three-axis mechanical gimbal according to claim 6, wherein the heating module is a power resistor.

16. The inertial measurement apparatus for the three-axis mechanical gimbal according to claim 7, wherein the heating module is a power resistor.
